(19) United States
(12) Patent Application Publication
(10) Pub. No.: US 2010/0280644 A1
(43) Pub. Date: Nov. 4, 2010

(54) METHOD FOR DETERMINING AT LEAST ONE CONTROL PARAMETER OF A CONTROL ELEMENT IN A WEB TENSION CONTROL CIRCUIT FOR A PROCESSING MACHINE

(76) Inventors: Holger Schnabel, Rottendorf (DE); Stephan Schultze, Lohr-Wombach (DE); Mario Goeb, Wuerzburg (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/771,068

(22) Filed: Apr. 30, 2010

(30) Foreign Application Priority Data
Apr. 30, 2009 (DE) 10 2009 019 642.2

(51) Int. Cl. G06F 19/00

(52) U.S. Cl. 700/103; 700/122

(57) ABSTRACT

The invention relates to a method for determining at least one controller parameter of a control element in a web tension control circuit for a processing machine for processing a web of material, in particular a shaftless printing press. The at least one controller parameter is determined as a function of at least one parameter characterizing the web of material, at least one parameter characterizing the processing machine, and at least one idle time.

### CROSS-REFERENCE TO RELATED APPLICATION

This application is based on German Patent Application 10 2009 019 624.2 filed Apr. 30, 2009.

### BACKGROUND OF THE INVENTION

1. Field of the Invention

The present invention relates to a method for determining at least one controller parameter of a control element in a web tension control circuit for a processing machine, to a correspondingly arranged computation unit, to a corresponding computer program, and to a corresponding computer program product.

Although below reference is made primarily to printing presses, the invention is not limited to them but instead is directed to all types of processing machines in which a web of material is processed. However, the invention is especially applicable to such printing presses as newspaper printing presses, job printing presses, intaglio printing presses, packaging printing presses, or securities printing presses as well as in such processing machines as bag-making machines, envelope-making machines, or packaging machines. The web of material may be of paper, fabric, cardboard, plastic, metal, rubber, or may be in sheet form, and so forth.

2. Description of the Prior Art

In applicable processing machines, in particular printing presses, a web of material is moved along driven shafts (web conveyor shafts and web conveyors), such as tension rollers or feed rollers, and nondriven shafts, such as deflection, guide, drying or cooling rollers. The web of material is simultaneously processed, for instance printed, stamped, cut, folded, and so forth, by means of processing shafts that are usually also driven. The driven shafts affect both the web tension and the processing register, such as the color register or longitudinal register.

In printing presses, besides a longitudinal and/or lateral register, for instance, the web tension is often also regulated, to attain an optimal outcome of printing. Known controllers, such as P-controllers, D-controllers, I-controllers, and so forth and arbitrary combinations of them, include controller parameters that have to be adjusted. Typical controller parameters are the proportional gain K_{P}, the integral gain K_{I}, the differential gain K_{D}, the reset time T_{N}, the rate time Tᵥ, delays T, and so forth.

The controller parameters in the prior art are ascertained or adjusted manually, for instance via evaluating a jump response. To that end, the guide variable is changed, and the system performance is examined or optimized to that change in a set-point value. Next, for instance by a machine user, the controller parameters are changed, and for that reason the user must have skills in automatic control technology and must adjust the parameters individually. One known parametrizing method employs the Ziegler-Nichols tuning rules, for example.

If the type of controlled system and its system parameters are known, then besides manual parametrizing, a calculated parametrizing is also possible. This requires modeling the control circuit being observed. The control circuit structure comprises at least the two elements, that is, the controller and the controlled system (system performance). The system performance of a control motion, for instance of a printing unit, is typically modeled as a PT1 element with a speed-dependent time lag T(v)_{S}. In terms of control technology, the system performance is typically designed with the aid of a PI controller in such a way that the open control circuit results in a second order system. Various design criteria exist for the P gain and the I component.

The time constant of the controlled system is proportional to the length of the web of material of the web tension portion to be regulated between two clamping points and is inversely proportional to the speed v of the web of material. The length of the portion is typically constant during a production run and varies only upon production conversions and can optionally be assumed to be a constant. The result is simplification, because the system time constant is assumed to be only proportional to 1/v. In the prior art, the controller parameters are adapted with this speed-dependent time constant. Known adjustment methods are employed, such as the symmetrical optimum or root locus method.

The properties of the controlled system also depend on the physical parameters of the web of material. In German Patent Disclosure DE 103 45 593 A1, it is shown that ascertained module of elasticity of the web of material can be utilized for controller parametrizing. German Patent Disclosure DE 36 05 168 A1 shows how controller parameters of a PI controller can be adapted to the physical parameters of web cross section and modulus of elasticity of the web of material.

In European Patent Disclosure EP 1 790 601 A2, it is shown that controller parameters can be determined as a function of web of material parameters (such as the modulus of elasticity), machine parameters (such as the length of the web of material, speed of the web of material, or moment of inertia), and operating parameters (such as control deviation).

In German Patent Disclosure DE 10 2008 035 639, which had not been published prior to the filing date of the present application, it is shown that along with these variables, idle times are also present in the controlled system and can be used for ascertaining the controller parameters.

The known methods have the disadvantage that on the one hand, the controller parameters have to be input manually, which typically does not lead to optimal control, and on the other, the methods for automatic adaptation are not yet sophisticated enough that optimal results, particularly in terms of the disturbance rejection performance, can be attained. Adapting the parameters once ascertained to new conditions also entails repeating the method and is thus also relatively time-consuming.

### OBJECT AND SUMMARY OF THE INVENTION

Against this background, with the present invention a method for determining at least one controller parameter of a control element in a web tension control circuit for a processing machine, and a computation unit for performing the method, are proposed. Advantageous refinements are the subject of the ensuing description.

In the method of the invention, the at least one controller parameter, such as the proportional gain K_{P} and/or the reset time T_{N} of a PI element, is determined as a function of at least one parameter characterizing the web of material, such as the modulus of elasticity and/or the cross section, at least one parameter characterizing the processing machine, such as the web speed and/or the segment length, and at least one idle time, which in particular is constant (that is, not dependent on the web speed) and/or speed-dependent, such as a transmission time and/or a measurement time. The determination is expediently also done multiple times or cyclically during the control activity or operation of the processing machine, in order to adapt the at least one controller parameter constantly to the prevailing conditions (so-called adaptation).

The invention thus for the first time combines taking web of material parameters, machine parameters, and time parameters into account. According to the invention, in addition to the system performance, typically modeled by means of a quotient of the segment length and the web speed, the T_{V} being characterized by a web speed-dependent time lag T_{(V)}S, at least one idle time as well as at least one web of material parameter are also taken into account in determining the at least one controller parameter. One preferred possibility for taking idle times into account is disclosed in German Patent Disclosure DE 10 2008 035 639 of the present Applicant (entitled “Verfahren zur Modellierung eines Regelkreises für eine Bearbeitungsmaschine” [“Method for Modeling a Control Circuit for a Processing Machine”]), to which reference is explicitly made at this point. One skilled in the art can learn from DE 10 2008 035 639 how idle times can be taken into account in controller parametrizing.

By means of the embodiments according to the invention, in comparison to the prior art, optimized modeling of the web tension control circuit that is the basis of a processing machine can be attained, and based on that, controller parameters can be determined. By the inventive combination of taking into account both machine parameters and web of material parameters and constant and/or speed-dependent idle times, good results can be attained in many ranges. For instance, a speed-dependent idle time typically has a major influence at low speeds, and its influence decreases as the web of material speed increases. However, precisely in this speed range, the influence of constant idle times is especially disruptive, since by definition they do not display any speed dependency, and thus in these speed ranges the system performance can dominate. Besides, the web of material parameters such as the modulus of elasticity, cross section (thickness and width) or mass per unit of surface area, the reaction of the controlled system to a control event, and therefore taking these parameters into account improves the control still further. The control circuit modeled by taking these variables into account can be used for determining the controller parameters automatically by means of conventional methods. Thus the controller parameters are optimally adapted to the fundamental processing machine, and manual input by a user can be dispensed with. Hence this precludes a significant source of error in the machine setup.

Some of the parameters entering into the determination, such as the modulus of elasticity or segment length, can vary during the processing method. It is therefore expedient if the determination is performed during the processing method either regularly or when tripped by a change. This determination can in particular be done automatically within a computation unit, such as a computation unit or a web tension controller. With this preferred embodiment of the invention it is thus possible at any time in processing to furnish optimal parametrizing of the controllers automatically.

It is advantageous that the at least one controller parameter is determined as a function of a predeterminable weighting factor. Often, controller parameters that are calculated on the basis of theoretical design prove not to be optimal in practice. These can be ascribed to additional, unascertainable time lags, nonlinearities, signal noise, incorrectly determined system parameters or the control quality or web tension performance in constant operation. This last aspect in particular is usually disadvantageous. Although the control circuit does respond quickly, nevertheless in constant operation, because of the discretizing or quantification of the measurement results or controlling variables, there is often unrest because of a relatively “powerful” proportional component. Advantageously, a method is proposed in which as a further input variable, a weighting factor is indicated, for instance as a standard for “controller sharpness”. For instance, either one or all the theoretically ascertained controller parameters can be multiplied by the weighting factor (for instance between 0 and 1 but also greater than 1). With the aid of this input parameter, the user can adapt the controller parameters as needed. For instance, this can be attained with a PI control element by multiplying the proportional gain with this percentagewise factor. Alternatively, in addition to a weighting factor, a selection from among predefined values can be made (such as 20%, 40%, 50%, 60%, 70%, 80%, 85%, 90%, 95%, 100%, 105%, etc.).

Advantageously, a value for at least one of the parameters characterizing the web of material, such as the modulus of elasticity, can be extracted from a database. Most parameters, such as speed, length (for instance, the length of the web of material between the processing units), idle times, or web of material dimensions, are typically known. Conversely, the modulus of elasticity and the tension-elongation characteristic are usually not known. It is proposed that a database with values for the modulus of elasticity of typical types of web of material be provided, so that the user now needs merely to indicate the material comprising the web of material. It may be provided that the database can be expanded—on the order of prescription management—with values ascertained by the user. Also advantageously, the value for the at least one parameter characterizing the web of material can be stored in memory as a function of ambient parameters (such as temperature and moisture content of the web of material) or other variables. A determination of the modulus of elasticity of the web of material is disclosed for instance in German Patent Disclosure DE 102 25 824 A1 or German Patent Disclosure DE 103 22 098 A1, to which reference is made here with regard to further details.

It is also advantageous if as an alternative or in addition, a value for at least one parameter characterizing the web of material, such as the modulus of elasticity, and/or at least one parameter characterizing the processing machine, such as the web length, is measured, estimated, or determined by means of observation with control technology. For instance, a change in the modulus of elasticity can be caused by changes in temperature and/or moisture content. The web length of a web tension segment for instance changes as a result of the opening or closure of a defining clamping point, which is for instance known in the higher-order computation unit and can be taken into account. With the aid of a measurement, an observer, and/or a parameter estimating process, changes in the at least one characterizing parameter can be identified during operation in order to adapt the at least one controller parameter.

In a feature of the invention, a design criterion is predetermined for determining the at least one controller parameter. For designing controller parameters, various design criteria are known in the literature (such as symmetrical optimum, root locus method, quantitative optimum, or Ziegler-Nichols). By predetermining the criterion to be used in particular in the computation unit of the invention for determining the at least one controller parameter, the quality and speed of determination can be varied.

Expediently, the at least one controller parameter is determined as a function of a control deviation and/or a change in set-point and/or a predetermination of a machine status. This dependency can for instance have an influence on the design criterion or the weighting factor described above. Because of the fact that in normal operation of a corresponding machine, as a rule no further changes in the set-point value should occur, in practice optimization to the disturbance rejection performance, that is, an action in performance to changes in the actual value or in the event of interference variables involving the controlled system, is often parametrized. In the case of optimizing controller parameters with regard to the disturbance rejection performance, however, the control behavior in reaction to changes in the guide variable (set-point value) by the then-selected parametrizing of the controllers is not optimal. This can lead to reduced dynamics or to a tendency of the control circuit to oscillate. In effect, this means that upon optimization to the disturbance rejection performance, in which disturbances are supposed to be eliminated as optimally as possible, the consequence can be substantially poorer system performance (for instance, a tendency of the system to oscillate) in the guide performance. For instance, the setup process for a printing press can be named. During this process, set-point values are typically changed by a user of the machine, and the outcome is made accessible to the user by observation or measurement at the controlled system. During the setup, relatively major adjustments often have to be made in proportion to the later operation of the machine. Optimizing to the disturbance rejection performance often means a long waiting time until the change in set-point value made appears stable after the transient effects at the system output have ended, or in other words becomes observable. In the later course of the machine, the set-point value changes are usually rather limited or of reduced dynamics, so that the duration of the transient effects is of rather subordinate relevance. Therefore, depending on the machine status, different controller settings may be advantageous.

With the preferred embodiment, it is possible to determine controller parameters as a function of the actual operating state.

Advantageously, at least one constant idle time includes a data transmission time from a sensor to a computation unit, a measurement time or computation time of a sensor, and/or a computation time of a computation unit. In a processing machine designed as a printing press, in particular an intaglio press, the web tension sensors are typically disposed at a certain distance from the computation unit that is responsible. An idle time that is advantageous to take into account is accordingly due to the transmission time between a sensor and the computation unit to which the sensor is connected. The transmission of the measured values from the sensors to the computation units can be done for instance via a network or a field bus. Another idle time that is advantageous to take into account results from a measurement time of a sensor until a measured signal is furnished at a sensor output. Finally, a computation unit employed also contains an idle time, which is defined by the span of time between the reception of the measured value from the sensor and the output of the control value to the controlled system. The sum of the constant idle times is typically in the range from 10 to 200 ms. It is expedient if one or all of the idle times mentioned can be input from outside, ascertained automatically, or called up via a bus system. Data transmission times can be ascertained for instance using time synchronization processes. Measurement times and computation times can be measured.

It is an attractive option to model at least one speed-dependent idle time as a function of a segment length and a web speed. A speed-dependent idle time is for instance due to the fact that a control command of the computation unit or controller is not effective immediately. For instance, a speed adjustment of a cylinder does not take place abruptly but instead is distributed in ramplike fashion over the acceleration of the print cylinder. The result is a soft adjustment, which affects the printing process and web transportation only slightly. This ramplike distribution of an adjustment can for instance be modeled as an idle time. Speed-dependent idle times are also due to the discrete-time sampling of the outcome of the controlled controller. For instance, the controller in a printing press might receive a new measured value for ascertaining the control deviation only once per print cylinder revolution. One or both of the idle times mentioned so far can be modeled as a function of a segment length and a web speed, and a proportionality with the quotient of the segment length and web speed is an especially attractive option.

In an advantageous embodiment of the invention, the at least one constant and/or the at least one speed-dependent idle time is combined in a control circuit element or in a total time.

It is an attractive option to model this control circuit element as a PT1 element, for instance. In this way, all the idle times taken into account can be taken into account as a total time inside the control circuit, which particularly simplifies the modeling of the control circuit. Depending on the embodiment of the invention, the total time element thus includes a web of material speed, a segment length, or in other words the length between two clamping points, a data transmission time from a sensor to a computation unit, a measurement time of a sensor, and/or a computation time of a computation unit. This embodiment of the invention offers the advantage that all the variables involved are either geometric or physical parameters of the processing machine, which have to be determined only a single time, or parameters such as the web speed, which are known within the machine or can easily be determined. The total time can be used especially simply for determining the at least one controller parameter.

It is an attractive option to perform the determination of the at least one controller parameter as a function of a family of characteristic curves. As has already been explained above, only a few changing variables enter into the modeling as a parameter, while conversely many variables are fixed, such as spacings, constant idle times, and so forth. For this reason, it is an attractive option to furnish families of characteristic curves as a function of the changing variables, such as the web speed, which families of characteristic curves can be stored in memory, for instance in a memory device of the computation unit. In this way, the automatic parametrizing of the controllers can be speeded up significantly.

A computation unit according to the invention, such as a control or regulating unit of a processing machine, is set up, in particular by program technology, to perform a method of the invention. In particular, the computation unit has an interface by way of which the computation unit can be supplied with the applicable parameters in accordance with the above description. The parameters can be predetermined manually, for instance, or loaded from a memory, measured, estimated, observed, or the like.

Implementing the method in the form of software is also advantageous. This makes especially low costs possible, especially if a computation unit performing the method is used for other tasks as well as is therefore already present. Suitable data media for furnishing the software are in particular diskettes, hard drives, flash drives, EEPROMs, CD-ROMs, DVDs, and many more. Downloading a program via computer networks (Internet, intranet, etc.) is also possible.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 is a schematic illustration of a processing machine, which is embodied as a printing press and for which the method of the invention is suitable;

FIG. 2 shows a schematic illustration of a modeled control circuit for a processing machine;

FIG. 3 shows the control circuit of FIG. 2 in a transformed quasi-continuous illustration;

FIG. 4 shows the control circuit of FIG. 3 in a simplified illustration; and

FIGS. 5 through 9 show designs of function components for determining controller parameters in accordance with various preferred embodiments of the invention.

### DESCRIPTION OF THE PREFERRED EMBODIMENTS

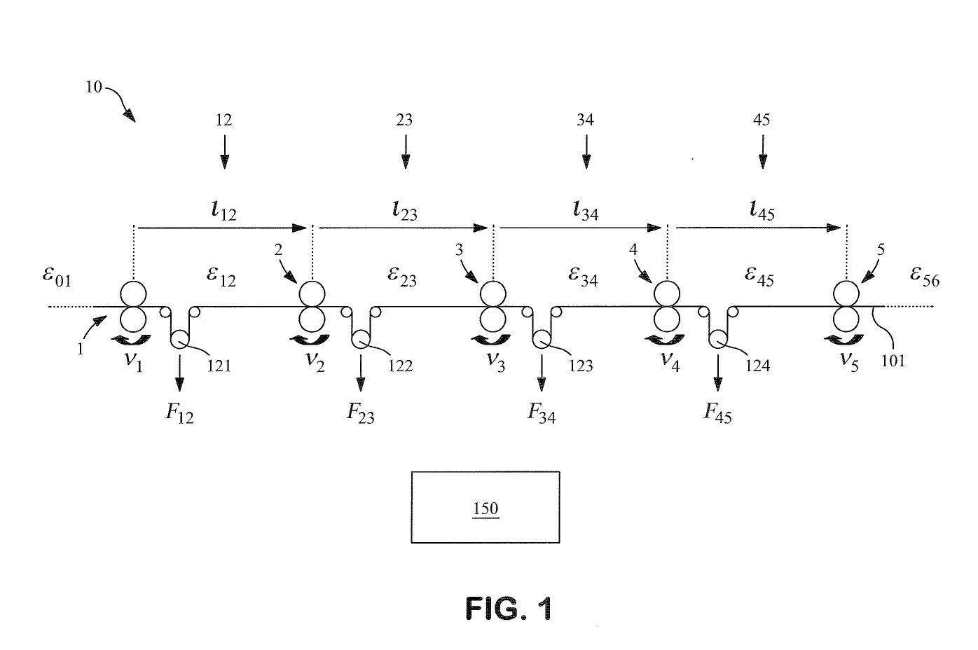

In FIG. 1, a schematic detail of a printing press 10 is shown, in which a web 101 of material is transported and processed by means of five clamping points, embodied here as printing units 1 through 5. Between each two adjacent clamping points, one web tension segment is embodied. For instance, a web tension segment 12 is defined by the printing units 1 and 2; one web tension segment 23 is defined by the printing units 2 and 3, one web tension segment 34 is defined by the printing units 3 and 4, and one web tension segment 45 is defined by the printing units 4 and 5. Instead of printing units, conveyor mechanisms, such as delivery or removal mechanisms, may equally well be pertinent.

The printing press further has web tension sensors 121 through 124, embodied here as measuring cells, for ascertaining the web tension or the tensile force in the various web tension segments. In the illustration shown, the web tension is adjusted via the circumferential speeds v₁ through v₅ of the printing units 1 through 5.

The physical parameters, namely the length 1, the elongation E and the web tension or tensile force F of the various web tension segments are also shown in the drawing.

For adjusting the web tension or for adjustment in the web tension segment 34, two strategies are known. In the upstream strategy, the printing unit 3 (and optionally, printing units upstream of it) is adjusted, and in the downstream strategy, the printing unit 4 is adjusted. Increasing the speed of the downstream clamping point causes a reduction in the web tensile force, and increasing the speed of the upstream clamping point causes a rise in the web tensile force. As a result, both a positive and negative control direction are described simultaneously. The positive control direction is thus equivalent to control by means of the rearward defining clamping point as a control signal (downstream), since here an increase in the control signal simultaneously causes an increase in the output signal. Conversely, an increase in the speed of the forward clamping point (upstream) causes a drop in the web tensile force, and therefore this behavior is defined by the term “negative control direction”. For performing the web tension control, the web tension values detected by the sensors 121 through 124, of a device for web tension control (tension controller) are delivered inside a computation unit 150. The tension controller controls the speeds v₁ through v₅ as a function of the web tension values.

In the embodiment shown, the tension controller is parametrized automatically, using the method of the invention.

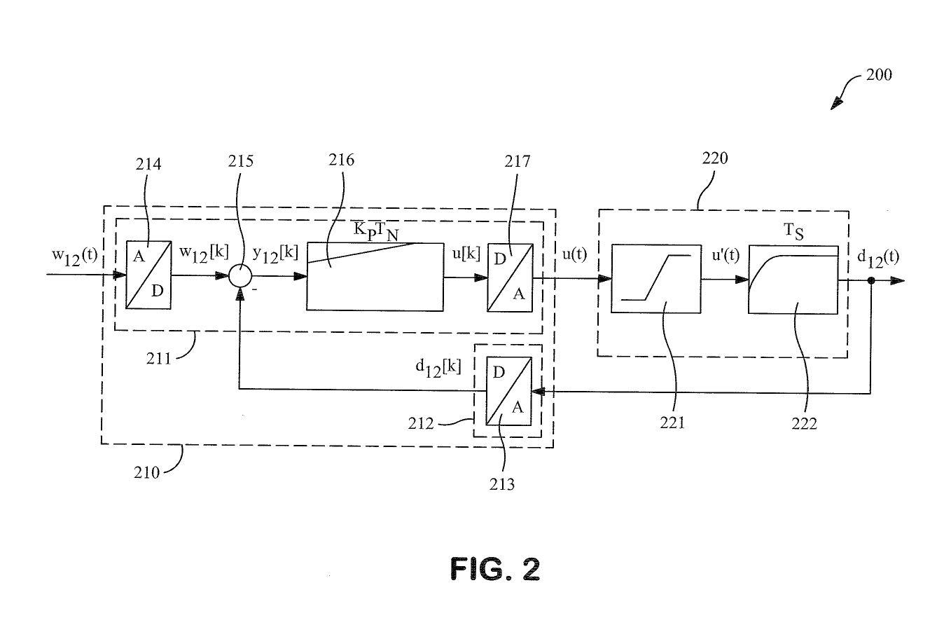

In FIG. 2, a web tension control circuit, modeled using the findings according to the invention, is shown schematically and identified overall by reference numeral 200. The control circuit can for instance be based on a printing press of FIG. 1, pertaining to the web tension control in segment 12. Based on the properties of the fundamental processing machine, the control circuit 200 can be divided up into a discrete-time component 210 and a continuous-time component 220. In the continuous-time component 220, there is an element 221 which models the ramplike speed increase of a print cylinder in reaction to a control command by the amount of u(t). The control command u′(t) modeled in ramplike fashion is forwarded to the controlled system 222 with the system time T_{S}.

The discrete-time component 210 includes a web tension controller part 211, which contained in a register controller, such as an SPS like the computation unit 150, and a part 212, which is contained in a sensor, for instance in the sensor 121. The sensor is modeled by an analog/digital element 213, which delivers the continuous controlled variable d₁₂(t) (corresponds to F₁₂(t) as a discrete-time feedback variable d₁₂[k] to a comparison point 215.

The web tension controller part 211 likewise includes an analog-digital element 214, which from the continuous guide variable w₁₂(t) calculates the discrete-time guide variable w₁₂[k]. This analog-digital element 214 can be omitted, if the guide variable can already be input in digital form in the computation unit. The comparison element 215 calculates the discrete-time control error or control different y₁₂[k], which is delivered to the actual control element 216. The control element 216 is embodied as a PI element as an example, but many other types of controller are also possible, such as PID controllers, status controllers, etc. From a discrete-time controller output variable u[k], the continuous-time controlling variable u(t) (corresponds for instance to v₁₂(t) or a fine calibration or gear factor) is calculated in a digital-analog element 217.

Within the control circuit 200, in a particular preferred embodiment of the invention, both constant and speed-dependent idle times are taken into account. The controlled variable d₁₂(t) is detected by a sensor, and a measurement time is required that is taken into account as an idle time T_{t,SENSOR} and can amount to approximately 10-100 ms. This idle time belongs to the element 213.

The feedback variable d₁₂[k] is delivered to the tension regulator via a connecting line, which requires a certain transmission time that is taken into account as a further idle time T_{t,NET}. This time varies within the range of approximately 1-20 ms. Finally, the web tension error y₁₂[k] and the controlling variable u[k] are calculated in the tension controller, such as an SPS, which once again leads to an idle time T_{t,SPS} that amounts to approximately 1-20 ms.

In the described embodiment of the invention, these constant idle times are taken into account in addition to speed-dependent idle times, which are typically modeled in proportion to a ratio of the length and the web of material speed.

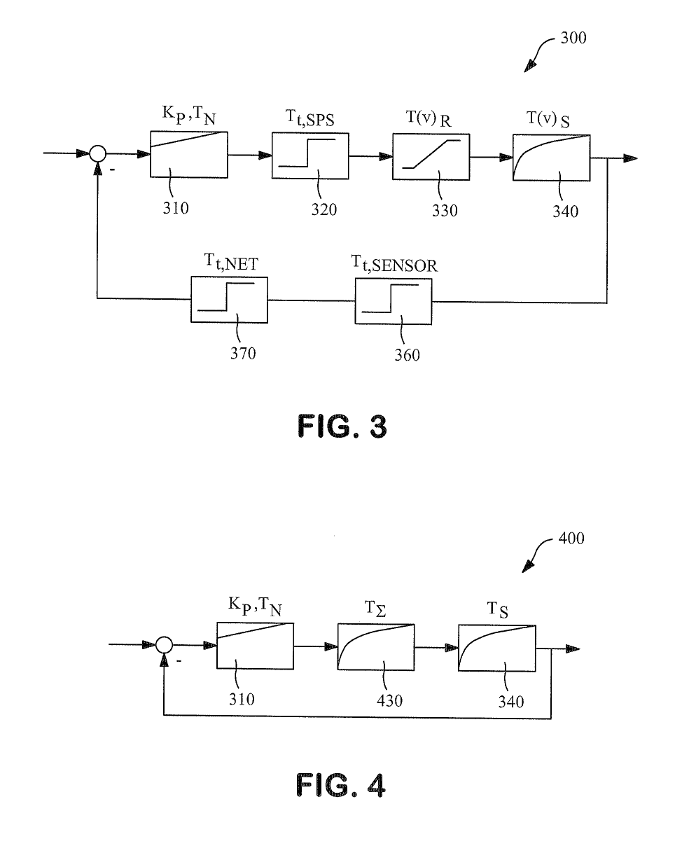

In a further preferred embodiment of the invention, the idle times just described can be combined within the control circuit in a control circuit element, as will be described in further detail in conjunction with FIG. 3.

In FIG. 3, the control circuit of FIG. 2 is shown in a simplified view and identified overall by reference numeral 300. In this view, the individual control circuit elements are shown.

The control circuit 300 includes a PI element 310 with a control gain K_{P} and a reset time T_{N}. The constant idle time that is due to the computation time of the computation unit is shown in an idle time element 320 with the idle time T_{t,SPS}. The speed-dependent idle time T(v)_{R}, which is engendered by the ramp behavior of the controlling variable, is modeled in an element 330. The system performance with the speed-dependent system times T(v)ₛ, finally, is modeled in a PT1 element 340.

In the return, the constant idle time T_{t,SENSOR} resulting from the measurement time of the sensor is modeled in an idle time element 360. The constant idle time T_{t,NET} resulting from the data transmission is modeled in an idle time element 370. The time lag that occurs from the conversion of the continuous signal to a discrete-time signal and of the discrete-time signal to a continuous signal is taken into account. As a rule, the influence of the so-called sample-and-hold element is taken into account with half the sampling time in the control circuit.

In a further preferred embodiment of the invention, the idle time elements 320, 330, 360 and 370 just described can be combined in a control circuit element of the kind shown in conjunction with FIG. 4. In FIG. 4, the control circuit of FIG. 3 is shown in a further-simplified view and identified overall by reference numeral 400.

The control circuit 400 now includes both the PI element 310 and the controlled system 340 of FIG. 3. The idle time elements of FIG. 3 are combined in one control circuit element 430, which is characterized by a total time T_{S}. The control circuit element 430 can be adapted by means of PT1 behavior. It is understood that besides this, still other control technology adaptations are possible. The position of the control circuit element 430 within the control circuit 400 can be selected by the person skilled in the art assigned to the task. For instance, the control circuit element 430 can also be disposed in the return, which would have an influence only on the guide transmission function but no influence on the controller design. The total time T_{S} used in the preferred embodiment is advantageously suitable for determining the controller parameters, as will be explained below.

The controller parameters K_{P} and T_{N} of the PI element 310, in the example selected, are dependent on the web width b and web thickness d of the web of material 101, the web length l₁₂ of the segment to be controlled between the adjacent clamping points of printing units 1 and 2, the web material, and the time lags or idle times. Beginning with a PI control element having the transmission function G(s)=K_{P} (1+l/(T_{N}s)), the following preferred controller parameter relationships can be given:

The proportional gain K_{P}, as a function of the modulus of elasticity E, the web cross section A, the segment length 1, the web speed v, and substitute time constants T_{E}, becomes

$${K}_{P} ∼ \frac{l}{v \cdot {T}_{E} \cdot E \cdot A}$$

The reset time T_{N} is proportional to the substitute time constants T_{E} of idle times, signal smoothing operations, etc., which in the example selected can be described by the total time T_{S} indicated farther above: T_{N}˜T_{E}=Tₛ.

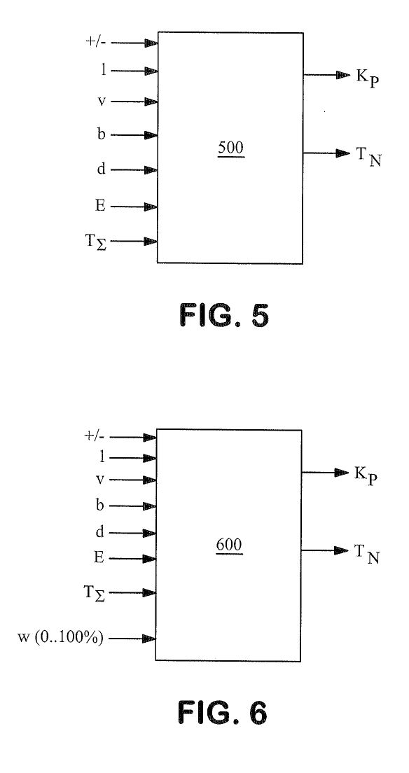

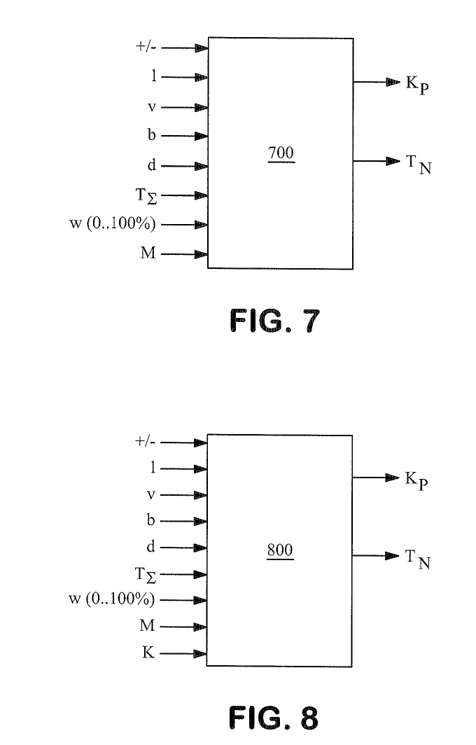

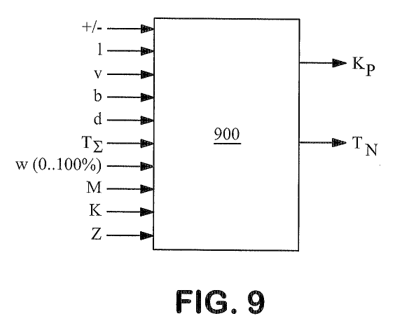

A selection of preferred algorithms (programmed for instance in SPS function modules) for describing the controller parameter determination will be described below comprehensively and cohesively in conjunction with FIGS. 5 through 9, in which identical elements are identified by the same reference numerals.

In FIGS. 5 through 9, function modules 500, 600, 700, 800 and 900 for determining the controller parameters Kₚ and T_{N} are shown. In each case, different input variables are present on the left-hand side, and these, possibly optionally, enter into the determination of the controller parameters.

It is preferably provided that the control direction, which has been explained above in conjunction with the upstream and downstream adjustment, is delivered optionally to the function module. The control direction is indicated by + and − in the drawings. The control direction essentially affects only the sign of the controller output variable and can thus also instead be delivered to a different location within the control circuit.

It is furthermore provided that the web segment length l, web speed v, web width b, web thickness d, and the total time Tₛ be delivered each of the function modules shown.

In addition, the modulus of elasticity E of the web of material is also delivered to the function components 500 and 600.

In another preferred feature, which is represented by the function module 600, a control circuit w is also used for determining the controller parameters; this control circuit can be between 0 and 100%, for instance (values greater than 100% are also conceivable). As already described above, the control circuit w affects the so-called controller sharpness.

A further preferred embodiment is represented by the function module 700. The function module 700 differs from the function module 600 in that instead of the modulus of elasticity E, it is the material type M that is delivered, since inside the function module 700, a database is provided in which a number of modulus of elasticity values for certain types of material are stored. Thus in controller parameter parametrizing, the user need only also indicate the type of material.

The function module 800 differs from the function module 700 in having the additional capability of indicating the design criterion K.

Finally, an item of information Z pertaining to the machine status can also be delivered to the function module 900. Z can for instance indicate that a production status or a setup status is present. In other words, Z indicates whether the machine is in operation or is still being set up for operation.

It is understood that in the drawings shown, only exemplary embodiments of the invention are shown. Besides them, any other embodiment is conceivable without departing from the scope of this invention.

The foregoing relates to preferred exemplary embodiments of the invention, it being understood that other variants and embodiments thereof are possible within the spirit and scope of the invention, the latter being defined by the appended claims.

We claimed:

1. A method for determining at least one controller parameter of a control element in a web tension control circuit for a processing machine for processing a web of material, in particular a shaftless printing press, comprising the method step of:
determining the at least one controller parameter as a function of at least one parameter characterizing the web of material, at least one parameter characterizing the processing machine, and at least one idle time.

2. The method as defined by claim 1, further comprising a processing step of performing regularly or in triggered fashion the step of determining the at least one control parameter.

3. The method as defined by claim 1, wherein the at least one controller parameter is determined as a function of a predeterminable weighting factor.

4. The method as defined by claim 2, wherein the at least one controller parameter is determined as a function of a predeterminable weighting factor.

5. The method as defined by claim 1, wherein a value for at least one parameter characterizing the web of material is extracted from a database.

6. The method as defined by claim 4, wherein a value for at least one parameter characterizing the web of material is extracted from a database.

7. The method as defined by claim 1, wherein a value for at least one parameter characterizing the web of material and/or for at least one parameter characterizing the processing machine is measured, estimated, or determined by means of observation using automatic control technology.

8. The method as defined by claim 6, wherein a value for at least one parameter characterizing the web of material and/or for at least one parameter characterizing the processing machine is measured, estimated, or determined by means of observation using automatic control technology.

9. The method as defined by claim 1, wherein a design criterion for determining the at least one controller parameter is predetermined.

10. The method as defined by claim 8, wherein a design criterion for determining the at least one controller parameter is predetermined.

11. The method as defined by claim 1, wherein the at least one controller parameter is determined as a function of a control deviation and/or a change in set-point and/or a predetermination of a machine status.

12. The method as defined by claim 10, wherein the at least one controller parameter is determined as a function of a control deviation and/or a change in set-point and/or a predetermination of a machine status.

13. The method as defined by claim 1, wherein the at least one controller parameter is determined as a function of at least one constant idle time, which contains a data transmission time of a sensor to a computation unit, a measurement time of a sensor, and/or a computation time of a computation unit.

14. The method as defined by claim 12, wherein the at least one controller parameter is determined as a function of at least one constant idle time, which contains a data transmission time of a sensor to a computation unit, a measurement time of a sensor, and/or a computation time of a computation unit.

15. The method as defined by claim 1, wherein the at least one controller parameter is determined as a function of at least one speed-dependent idle time.

16. The method as defined by claim 13, wherein the at least one controller parameter is determined as a function of at least one speed-dependent idle time.

17. The method as defined by claim 15, wherein the at least one constant idle time and/or the at least one speed-dependent idle time are combined to make a total idle time.

18. The method as defined by claim 16, wherein the at least one constant idle time and/or the at least one speed-dependent idle time are combined to make a total idle time.

19. A computation unit, which is arranged for performing a method as defined by claim 1.

20. A computation unit, which is arranged for performing a method as defined by claim 14.
